(19) United States
(12) Patent Application Publication
(10) Pub. No.: US 2018/0105630 A1
(43) Pub. Date: Apr. 19, 2018

(54) METHOD FOR THE SYNTHESIS OF A COPOLYMER CONTAINING IMIDAZOLE PENDANT GROUPS

(71) Applicant: COMPAGNIE GENERALE DES ETABLISSEMENTS MICHELIN, Clermont-Ferrand (FR)

(72) Inventors: Claire RANNOUX, Morges (CH); Rachid MATMOUR, Clermont-Ferrand Cedex 9 (FR); Cédric LOUBAT, Castries (FR)

(73) Assignee: COMPAGNIE GENERALE DES ETABLISSEMENTS MICHELIN, Clermont-Ferrand (FR)

(21) Appl. No.: 15/562,842

(22) PCT Filed: Mar. 23, 2016
(86) PCT No.: PCT/EP2016/056307

§ 371 Date: Sep. 28, 2017

(30) Foreign Application Priority Data
Apr. 7, 2015 (FR) 1552964

(51) Int. Cl. C08F 236/08; C08K 3/013; C08K 5/00

(52) U.S. Cl. CPC C08F 236/08; C08K 5/0008; C08K 3/013

(57) ABSTRACT

A process for synthesizing a copolymer bearing imidazole pendant groups is provided. The process comprises the radical copolymerization of a monomer mixture comprising a terminal olefin and a functional monomer bearing a (meth)acryloyl group and an imidazole group.

This application is a 371 national phase entry of PCT/EP2016/056307, filed on 23 Mar. 2016, which claims benefit of French Patent Application No. 1552964, filed 7 Apr. 2015, the entire contents of which are incorporated herein by reference for all purposes.

### BACKGROUND

### 1. Technical Field

The present invention relates to a process for synthesizing a copolymer, the copolymer and the composition containing it.

### 2. Related Art

The chemical structure of a polymer generally has an impact on the chemical and physical properties of the polymer, and also the properties of the compositions containing it. Modifying the structure of a polymer, such as the functionalization of a polymer, is particularly sought for when it is desired to bring together a polymer and a filler in a composition. Chemically modifying a polymer can improve the dispersion of the filler in the polymer and can thus make it possible to obtain a more homogeneous material. In the case of certain fillers, such as carbon black or silica, a better dispersion of the filler will generally be reflected by a fall in hysteresis of the composition. Such a property is sought for, in particular in rubber compositions intended, for example, for tire applications.

The polymer preparation that makes it possible to improve the dispersion of filler in a polymer composition is highly documented. Mention may be made of the processes for modifying polymers by functionalizing a growing chain end of a polymer, by modifying one or more monomer units of the polymer, by copolymerization with a comonomer bearing a function that interacts with the reinforcing filler of the polymer chain. It is still worthwhile, in particular for tire manufacturers, to find new processes for obtaining new polymers that facilitate and improve the dispersion of the fillers in a polymer composition.

### SUMMARY

A process has been discovered that is relatively simple and flexible in its implementation which makes it possible to prepare a copolymer bearing imidazole pendant groups that makes it possible to improve the dispersion of a reinforcing filler in a polymer composition. The simplicity and the flexibility of the process lie in the accessibility of the reactants, in particular of the monomers, necessary for the purposes of the invention, and in having access to a great variety of microstructures of the copolymer.

Thus a first subject of the invention is a process for synthesizing a copolymer bearing imidazole pendant groups, which process comprises the radical copolymerization of a monomer mixture comprising a terminal olefin and a functional monomer bearing a (meth)acryloyl group and an imidazole group.

Another subject of the invention is a copolymer capable of being obtained by the process in accordance with the invention.

The invention also relates to composition, in particular a rubber composition, which is based on a reinforcing filler, a crosslinking system and a polymer matrix containing the polymer in accordance with the invention.

A further subject of the invention is a tire comprising the composition in accordance with the invention.

### DETAILED DESCRIPTION

In the present description, unless expressly indicated otherwise, all the percentages (%) shown are % by weight. The abbreviation “phr” means parts by weight per hundred parts of elastomer (of the total of the elastomers, if several elastomers are present).

Furthermore, any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The expression “composition based on” should be understood as meaning, in the present description, a composition comprising the mixture and/or the in situ reaction product of the various constituents used, some of these base constituents (for example the elastomer, the filler or other additive conventionally used in a rubber composition intended for the manufacture of tires) being capable of reacting or intended to react with one another, at least in part, during the various phases of manufacture of the composition intended for the manufacture of tires.

The polymerization process may be continuous or batchwise, in bulk, in solution, in suspension or in emulsion, in a fed batch or in a closed reactor. According to the desired microstructure and according to the reactivity of the monomers of the monomer mixture, a person skilled in the art will adapt the polymerization conditions, in particular to lead to a statistical copolymerization. For a radical polymerization, whether in solution, in suspension, in bulk or in emulsion, the monomers, the polymerization initiator and also the other constituents of the polymerization medium can be introduced into the reactor in a single charge at the start of the polymerization or continuously or sequentially throughout the polymerization.

The radical polymerization is carried out at temperatures varying from −10° C. to 200° C., preferably from 0 to 100° C., the temperature being chosen by a person skilled in the art taking into account in particular the reactivity of the polymerization medium and its concentration.

The polymerization initiator can be any conventional radical polymerization initiator, in particular, by way of example, an organic peroxide, such as benzoyl peroxide, lauroyl peroxide, tert-butyl hydroperoxide, cumyl hydroperoxide, para-menthyl hydroperoxide, di(tert-butyl) peroxide or dicumyl peroxide. Furthermore, the radical polymerization initiators can also include peracids and their esters, such as peracetic acid and potassium persulphate. Each radical polymerization initiator can be used alone or in combination with at least one other radical polymerization initiator.

Recourse may also be had, as radical polymerization, to controlled radical polymerization, which makes possible a high degree of control of the macrostructure and of the microstructure of the polymer. Controlled radical polymerization is known to a person skilled in the art and is described in numerous works. Controlled radical polymerizations include, for example, atom transfer radical polymerization (ATRP), nitroxide-mediated polymerization (NMP) or reversible addition-fragmentation chain-transfer (RAFT) polymerization.

In the reaction medium of radical polymerization, transfer agents, such as mercaptans, in particular tert-dodecyl mercaptan or n-dodecyl mercaptan, or such as carbon tetrachloride or else di- or triterpene, can also be used, alone or in combination.

For a radical polymerization carried out in emulsion, the surfactants employed in the emulsion polymerization can be anionic, cationic or nonionic, or amphoteric entities. They can be used alone or in combination.

For a radical polymerization carried out in suspension, the stabilizers employed in the suspension polymerization can, for example and non-exhaustively, be poly(vinyl alcohol), poly(sodium acrylate) or hydroxyethylcellulose.

The radical polymerization is carried out conventionally under an inert atmosphere, for example under nitrogen or under argon. The typical duration of the polymerization is between 15 min and 48 h, more commonly between 1 h and 24 h.

The functional monomer necessary for the purposes of the invention is a monomer that bears both a (meth)acryloyl group and an imidazole group.

In the present application, the (meth)acryloyl group denotes the acryloyl group or the methacryloyl group.

The imidazole group denotes the heterocyclic radical C₃H₃N₂, the carbon atoms of the ring possibly being substituted, in particular in order to form a ring as in the case of the benzimidazole radical.

According to one embodiment of the invention, the (meth)acryloyl group has a direct or indirect attachment to the nitrogen atom of the imidazole group. The functional monomer is preferably selected from the monomer of formula (I), the monomer of formula (II) and the mixture thereof, R being methyl or hydrogen, A an alkylene group that may contain one or more heteroatoms.

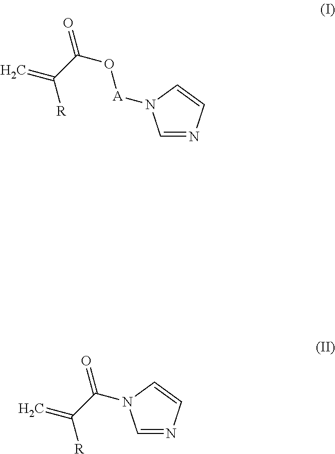

Among the functional monomers of formula (I), mention may be made of (1-imidazolyl)alkyl methacrylates such as 2-(1-imidazolyl)ethyl methacrylate, 2-(1-imidazolyl)methyl methacrylate, 2-(1-imidazolyl)ethyl acrylate, 2-(1-imidazolyl)methyl acrylate. Such compounds are, for example, described in U.S. Pat. No. 2,727,021 and U.S. Pat. No. 2,643,990.

Among the functional monomers of formula (I), mention may also be made of isocyanatoalkyl (meth)acrylate, the isocyanate function of which is blocked by the imidazole group. It may be a compound in which the symbol A of formula (I) represents the A1-NH—CO group in which the symbol A1 denotes an alkylene group preferably comprising from 1 to 6 carbon atoms. According to one embodiment of the invention, A1 is the 1,2-ethanediyl group. Suitable as functional monomer of formula (I) is for example the 1-imidazolecarbonylamino-2-ethyl ester of acrylic acid or of methacrylic acid. Such compounds are described in patent application EP 2 377 847 A1.

According to one particular embodiment of the invention, the functional monomer is preferably an isocyanatoalkyl (meth)acrylate, the isocyanate function of which is blocked by the imidazole group, more preferentially the 1-imidazolecarbonylamino-2-ethyl ester of acrylic acid or of methacrylic acid.

According to another particular embodiment of the invention, the functional monomer is N-acryloylimidazole or N-methacryloylimidazole. These compounds are, for example, described in U.S. Pat. No. 3,332,980.

The other monomer necessary for the purposes of the invention is a terminal olefin. In the present application, a terminal olefin is understood to mean a hydrocarbon-based compound having a carbon-carbon double bond at the end of the hydrocarbon-based chain.

Among the terminal olefins that are suitable, mention may be made of those containing 2 to 12 carbon atoms, whether they are aliphatic or aromatic.

According to one embodiment of the invention, the terminal olefin is ethylene, a conjugated diene or the mixture thereof.

The conjugated diene is, by definition of the terminal olefin, a 1,3-diene preferably containing 4 to 12 carbon atoms, preferentially butadiene, isoprene or the mixture thereof.

According to a first variant of this embodiment according to which the terminal olefin is ethylene, a conjugated diene or the mixture thereof, the monomer mixture comprises, in addition to the terminal olefin and the functional monomer, another monomer having an ethylenic double bond.

In the particular embodiment according to which the terminal olefin is ethylene, this other monomer is preferentially a vinyl ester of carboxylic acid having 1 to 4 carbon atoms, more preferably vinyl acetate. According to this particular embodiment, preferably the monomer mixture consists of ethylene, vinyl acetate and the functional monomer.

In the particular embodiment for which the terminal olefin is a conjugated diene, in particular butadiene, isoprene or the mixture thereof, this other monomer is preferentially a vinylaromatic compound having from 8 to 20 carbon atoms, more preferentially styrene. According to this particular embodiment, preferably the monomer mixture consists of the conjugated diene, the vinylaromatic compound and the functional monomer.

According to a second variant of the invention, the monomer mixture consists of the monofunctional monomer and the terminal olefin. This variant makes it possible to prepare copolymers of terminal olefin and of functional monomer. Knowing that the functional monomer may be a mixture of functional monomers and that the terminal olefin may also be a mixture of terminal olefins, this variant also makes it possible to prepare terpolymers and also copolymers having more than three monomer units.

According to one embodiment of the invention, the monomer mixture before polymerization comprises between 0.1 mol % and 50 mol % of functional monomer.

According to one particular embodiment of the invention, the monomer mixture before polymerization comprises between 0.1 mol % and 20 mol %, preferably between 0.1 mol % and 15 mol % of functional monomer.

According to one preferential embodiment of the invention, the monomer mixture before polymerization comprises between 50 mol % and 99.9 mol % of terminal olefin.

In the case of a fed batch, the concentration of a monomer is calculated on the basis of the total sum of monomers introduced into the reactor, which includes both the amount of monomers present at the start of polymerization and the amount of monomers added during polymerization.

According to any one of the embodiments of the first or second variant, preferably the amount of terminal olefin in the monomer mixture before polymerization is such that the copolymer prepared is an elastomer. When the terminal olefin is ethylene, a conjugated diene such as butadiene or isoprene, or a mixture of ethylene and conjugated diene, the terminal olefin preferentially represents more than 50% by weight of the monomer mixture, more preferentially more than 60% by weight of the monomer mixture.

The copolymer, another subject of the invention, is capable of being obtained by the process in accordance with the invention according to any one of its embodiments.

According to one preferential embodiment of the invention, the copolymer is a statistical copolymer.

According to another embodiment of the invention, the copolymer is an elastomer.

According to another preferential embodiment of the invention, the copolymer is statistical and an elastomer.

The number-average molar mass of the copolymer in accordance with embodiments of the invention may vary widely. Advantageously, it is between 1000 and 10 000 g/mol. In another variant, the copolymer has a number-average molar mass of between 5000 and 50 000 g/mol. In another variant, the copolymer has a number-average molar mass of between 50 000 and 150 000 g/mol. These ranges of average molar masses may apply to any one of the embodiments of the invention.

The composition, another subject of the invention, has the essential feature of being based on a polymer matrix containing the copolymer in accordance with embodiments of the invention, a reinforcing filler and optionally a crosslinking system.

“Polymer matrix” is understood to mean all the polymers contained in the composition.

The polymer matrix of the composition in accordance with embodiments of the invention has the essential feature of containing the copolymer in accordance with embodiments of the invention.

According to one embodiment of the invention, the copolymer is an elastomer, preferably containing, as terminal olefin units, ethylene units or conjugated diene units, in particular butadiene units or isoprene units. According to this embodiment of the invention, the copolymer in elastomer form preferably represents at least 50% by weight of the polymer matrix.

The polymer matrix may additionally comprise another elastomer, preferably a diene elastomer.

A “diene” elastomer (or equally “rubber”, the two terms being considered to be synonymous) should be understood, in a known way, to mean an (one or more is understood) elastomer resulting at least in part (i.e., a homopolymer or a copolymer) from diene monomers (monomers bearing two carbon-carbon double bonds which may or may not be conjugated). Suitable as diene elastomers are, for example, any diene elastomer selected from the group of highly unsaturated diene elastomers (namely comprising at least 50% by weight of units of diene origin which comprise a carbon-carbon double bond), consisting of polybutadienes (BR), polyisoprenes, butadiene copolymers, isoprene copolymers and the mixture thereof.

The following may be mentioned as reinforcing filler: carbon black, a mineral reinforcing filler such as silica, with which a coupling agent is combined in a known manner, or else a mixture of these two types of filler, such as a reinforcing silica or a carbon black. The coupling agent, especially a silane, (or bonding agent) is at least bifunctional intended to provide a sufficient chemical and/or physical connection between the inorganic filler (surface of its particles) and the polymer. Use is made in particular of at least bifunctional organosilanes or polyorganosiloxanes. Use is made in particular of silane polysulphides, referred to as “symmetrical” or “asymmetrical” depending on their specific structure, such as described, for example, in applications WO 03/002648 (or US 2005/016651) and WO 03/002649 (or US 2005/016650).

The composition may also comprise all or a portion of the usual additives customarily used in polymer compositions, such as, for example, plasticizers or extending oils, pigments, protective agents, such as antiozone waxes, chemical antiozonants, antioxidants, antifatigue agents or a crosslinking system.

The choice of the crosslinking system is made as a function of the chemical structure of the polymer matrix of the composition. The content of the compound or compounds that constitute the crosslinking system introduced into the composition is adjusted by those skilled in the art as a function of the targeted degree of crosslinking of the composition and of the chemical nature of the crosslinking system. This crosslinking level is defined according to the desired rigidity of the composition in the crosslinked state, this rigidity varying depending on the envisaged application of the composition.

The crosslinking system may be a system based on sulphur or based on peroxides, the choice of the crosslinking system being guided by the chemical nature of the polymer matrix to be crosslinked and the use of the composition. Typically, a peroxide-based crosslinking system will preferentially be chosen when the polymer matrix to be crosslinked has no diene units. Conversely, a sulphur-based system will preferentially be chosen for crosslinking a polymer matrix endowed with diene units.

For example, when the crosslinking system is a sulphur-based system, the sulphur possibly being provided by a sulphur donor, the crosslinking system may comprise, as is well known, vulcanization accelerators or retarders, and vulcanization activators in addition to the sulphur or sulphur donor. The sulphur is used at a preferential content of between 0.5 and 12 phr, in particular between 1 and 10 phr. The vulcanization accelerator is used in the rubber composition at a preferential content of between 0.5 and 10 phr, more preferentially of between 0.5 and 5.0 phr.

When the chemical crosslinking is carried out using one or more peroxide compounds, said peroxide compound or compounds represent from 0.01 to 10 phr. As peroxide compounds that can be used as chemical crosslinking system, mention may be made of acyl peroxides, ketone peroxides, peroxyesters, alkyl peroxides, hydroperoxides.

Advantageously, the composition is rubbery and is referred to as a rubber composition and its polymer matrix contains the copolymer in the form of elastomer and where appropriate the other elastomer defined previously.

The rubber composition according to embodiments of the invention can be manufactured in appropriate mixers, for example using two successive preparation phases according to a general procedure well known to those skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the chemical crosslinking agent, in particular the vulcanization system, is incorporated.

Generally, all the base constituents of the rubber composition, with the exception of the chemical crosslinking agent, namely the reinforcing filler and the coupling agent, if appropriate, are intimately incorporated, by kneading, into the elastomer matrix during the first “non-productive” phase, that is to say that at least these various base constituents are introduced into the mixer and are thermomechanically kneaded, in one or more steps, until the maximum temperature of between 130° C. and 200° C., preferably of between 145° C. and 185° C., is reached.

After incorporating all the ingredients of the rubber composition, the final rubber composition thus obtained is then calendered, for example in the form of a sheet or slab, in particular for laboratory characterization, or else extruded, in order to form, for example, a profiled element that is used as a component, in particular for the manufacture of the tire. The rubber composition in accordance with embodiments of the invention may be used in calendering form in a tire. The calendering or the extrudate formed from the rubber composition wholly or partly forms a semi-finished product, in particular of a tire.

Thus, according to one particular embodiment of the invention, the rubber composition in accordance with embodiments of the invention, that may be either in the uncured state (before crosslinking or vulcanization), or in the cured state (after crosslinking or vulcanization), is in a tire, for example in a tire tread.

The crosslinking (or curing), where appropriate the vulcanization, is carried out in a known manner at a temperature generally of between 130° C. and 200° C., for a sufficient time which may vary, for example, between 5 and 120 min, depending especially on the curing temperature, on the crosslinking system adopted and on the crosslinking kinetics of the composition in question.

The invention relates to both the tire in the uncured state (i.e. before crosslinking) and in the crosslinked state (i.e. after crosslinking).

The abovementioned characteristics of embodiments of the present invention, and also others, will be better understood on reading the following description of several exemplary embodiments of the invention, given by way of illustration and without limitation.

### Exemplary Embodiments

### 1. Characterization Methods

### Nuclear Magnetic Resonance (¹H NMR):

The contents of the various monomer units and their microstructures within the copolymers are determined by NMR analysis. The spectra are acquired on a 300 MHz Bruker spectrometer equipped with a 5 mm gradient QNP probe (¹H, ¹³C, ¹⁹F, ³¹P). The quantitative ¹H NMR experiment uses a simple 30° pulse sequence and a repetition time of 5 seconds between each acquisition. The samples are dissolved in deuterated chloroform (CDCl₃).

### Size Exclusion Chromatography (SEC):

Size exclusion chromatography (SEC) is used. SEC makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a polymer. The various number-average molar masses (Mn) and weight-average molar masses (Mw) can be determined from commercial standard products and the polymolecularity or polydispersity index (PI=Mw/Mn) can be calculated via a calibration.

Preparation of the polymer: There is no specific treatment of the polymer sample before analysis. The latter is simply dissolved, in tetrahydrofuran, at a concentration of approximately 1 g/l. The solution is then filtered through a filter with a porosity of 0.45 μm before injection.

SEC analysis: The equipment used is a Varian/GPC 50 Plus chromatograph. The elution solvent is tetrahydrofuran. The flow rate is 1 ml/min, the temperature of the system is 35° C. and the analytical time is 35 min. A set of two Agilent columns in series, with “Polypore” commercial names, is used.

The volume of the solution of the polymer sample injected is 100 μl. The detector is a differential refractometer and the software for evaluating the chromatographic data is the Cirrus system.

The calculated average molar masses are relative to a calibration curve produced with commercial polystyrene (PS) standards.

### 2. Synthesis of the Functional Monomers

### Example 1: Synthesis of the Monomer 1 of Formula (IIa)

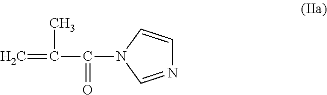

Introduced into a twin-neck round-bottom flask are 10 g of imidazole (0.147 mol), 17.17 g (0.17 mol) of triethylamine and 60 g of THF. The reaction mixture is maintained at ambient temperature then the methacryloyl chloride is added dropwise and with a countercurrent stream of argon. The mixture is subsequently left stirring at ambient temperature for 2 h. The conversion is complete after two hours. At the end of the reaction, the triethylamine salt is filtered, the THF is evaporated and a chloroform/water extraction is carried out. The organic phase is dried over Na₂SO₄, filtered and finally evaporated. The final product is a slightly viscous liquid obtained with a yield of 50%.

### Example 2: Synthesis of the Monomer 2 of Formula (Ia)

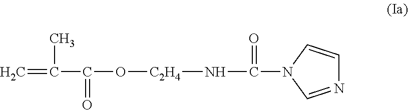

Introduced successively into a twin-neck round-bottom flask are 7 g of imidazole (0.1028 mol), 60 g of THF and 15.95 g (0.1028 mol) of isocyanatoethyl methacrylate. The mixture is subsequently left stirring at ambient temperature for 4 h. The conversion is complete after three hours. When the conversion is complete, add 150 ppm of 4-methoxyphenol (i.e. 4 mg) in order to stabilize the monomer. Next precipitate from pentane (4-methoxyphenol is also insoluble in pentane). The final product is a white powder obtained with a yield of 96%.

### 3. Synthesis of Copolymers Bearing Imidazole Pendant Groups According to a Process in Accordance with an Embodiment of the Invention

### Example 3: By Copolymerization of Isoprene and Monomer 1

Introduced successively into a 300 ml autoclave reactor are 16.3 g of monomer 1 (0.12 mol), 73.29 g of isoprene (1.078 mol), 70 g of toluene and finally 3.13 g (0.018 mol) of AIBN. The reaction medium is stirred magnetically and heated at 70° C. for 16 hours. At the end of the reaction, the copolymer is precipitated twice from methanol. The final product is a translucent elastomer.

The final product is analysed by SEC: Mn (PS eq)=4880 g/mol; Mw (PS eq)=8520 g/mol; PI 1.74.

The final product is analysed by ¹H NMR: the composition of the copolymer, expressed as a molar fraction, is the following:

x=0.06 (monomer 1); y=0.94 (isoprene)

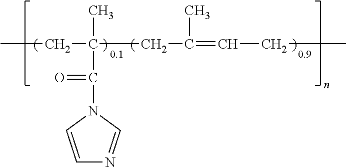

### Example 4: By Copolymerization of Isoprene and Monomer 2

Introduced successively into a 300 ml autoclave reactor are 22.8 g of monomer 2 (0.102 mol), 62.51 g of isoprene (0.919 mol), 50 g of toluene and finally 2.67 g (0.0153 mol) of AIBN. The reaction medium is stirred magnetically and heated at 70° C. for 16 hours. At the end of the reaction, the copolymer is precipitated twice from methanol. The final product is a translucent elastomer.

The final product is analysed by SEC: Mn (PS eq)=7020 g/mol; Mw (PS eq)=14800 g/mol; PI=2.10.

The final product is analysed by ¹H NMR: the composition of the copolymer, expressed as a molar fraction, is the following:

x=0.08 (monomer 2); y=0.92 (isoprene)

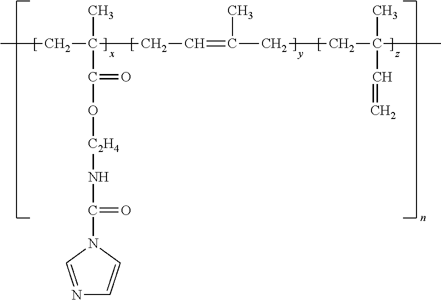

1. A process for synthesizing a copolymer bearing imidazole pendant groups, which process comprises radical copolymerization of a monomer mixture comprising a terminal olefin and a functional monomer bearing a (meth)acryloyl group and an imidazole group.

2. A process according to claim 1, in which the radical copolymerization is a statistical copolymerization.

3. A process according to claim 1, in which the terminal olefin is ethylene, a conjugated diene or the mixture thereof.

4. A process according to claim 3, in which the conjugated diene is butadiene, isoprene or the mixture thereof.

5. A process according to claim 1, in which the monomer mixture consists of the terminal olefin and the functional monomer.

6. A process according to claim 1, in which the monomer mixture additionally comprises another monomer having an ethylenic double bond.

7. A process according to claim 6, in which the terminal olefin is ethylene, and the other monomer having an ethylenic double bond is a vinyl ester of carboxylic acid having 1 to 4 carbon atoms.

8. A process according to claim 6, in which the terminal olefin is a conjugated diene, and the other monomer having an ethylenic double bond is a vinylaromatic compound having from 8 to 20 carbon atoms.

9. A process according to claim 1, in which the monomer mixture before polymerization comprises between 50 mol % and 99.9 mol % of terminal olefin.

10. A process according to claim 1, in which the monomer mixture before polymerization comprises between 0.1 mol % and 50 mol % of functional monomer.

11. A process according to claim 1, in which the monomer mixture before polymerization comprises between 0.1 mol % and 20 mol % of functional monomer.

12. A process according to claim 1, in which the functional monomer is selected from the monomer of formula (I), the monomer of formula (II) and the mixture thereof, 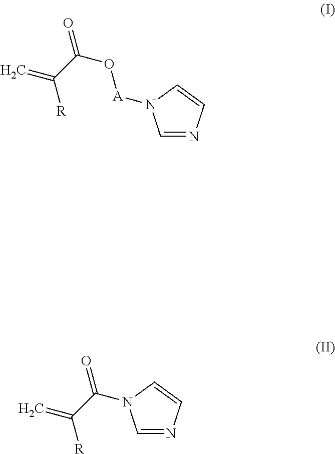
R being methyl or hydrogen,
A being an alkylene group that may contain one or more heteroatoms.

13. A process according to claim 12, in which the functional monomer is an isocyanatoalkyl (meth)acrylate, the isocyanate function of which is blocked by the imidazole group.

14. A process according to claim 13, in which A represents A1-NH—CO, A1 being an alkylene group.

15. A process according to claim 14, in which A1 is the 1,2-ethanediyl group.

16. A process according to claim 1, in which the functional monomer is N-acryloylimidazole or N-methacryloylimidazole.

17. A copolymer capable of being obtained by the process defined according to claim 1.

18. A process according to claim 17, which copolymer is an elastomer.

19. A composition based on a reinforcing filler, a crosslinking system and a polymer matrix containing the copolymer defined according to claim 17.

20. A composition according to claim 19, in which the copolymer is an elastomer and represents at least 50% by weight of the polymer matrix.

21. A tire which comprises a composition defined according to claim 19.
